(19) United States
(12) Patent Application Publication
(10) Pub. No.: US 2016/0128514 A1
(43) Pub. Date: May 12, 2016

(54) MOTOR UNIT, TOOL UNIT AND HAND BLENDER

(71) Applicant: KONINKLIJKE PHILIPS N.V., Eindhoven (NL)

(72) Inventors: Martin Ewald MERL, EINDHOVEN (NL); Sascha WEISS, EINDHOVEN (NL)

(73) Assignee: Koninklijke Philips N.V., Eindhoven (NL)

(21) Appl. No.: 14/897,046

(22) PCT Filed: Jun. 27, 2014
(86) PCT No.: PCT/EP2014/063678

§ 371 Date: Dec. 9, 2015

(30) Foreign Application Priority Data
Jun. 28, 2013 (EP) 13174341.1

(51) Int. Cl. A47J 43/044; H02K 7/08; H02K 7/00; H02K 7/14

(52) U.S. Cl. CPC A47J 43/044; H02K 7/145; H02K 7/08; H02K 7/003; A47J 2043/04427

(57) ABSTRACT

When food is being blended, chopped or cut using a hand blender, forces are executed from the tool unit onto the food and counterforces are executed from the food onto the tool unit (3). These forces are both in an axial and in a radial direction. The axial forces are being transmitted to the axial load bearing (23) located in the motor unit (2) of the hand blender (1). The transmission of the axial forces to the motor unit of the hand blender, instead of absorbing these forces in the tool unit, reduces the amount of heat dissipated in the tool unit. The radial forces are being absorbed by the bearing in the tool unit.

### FIELD OF THE INVENTION

The invention relates to a motor unit comprising a motor, a motor bearing and a motor coupling part driven by the motor for rotating a tool member.

The invention further relates to a tool unit with a tool coupling part to be driven by the motor unit.

The invention relates to a hand blender comprising a motor unit and a tool unit as well.

### BACKGROUND OF THE INVENTION

In conventional hand blenders axial and radial forces invoked by operation of a tool member, such as a blender, a chopper or a cube cutter, are supported in radial and axial load bearings placed close to each other. In tool members, such as a blender, bearings are usually placed in the bar. Heat generation and dissipation in this small area cause problems and require a complicated design. Often sinter parts are required and washer retaining rings are applied.

### OBJECT OF THE INVENTION

It is an objective of the invention to decrease the heat dissipation in the tool unit.

### SUMMARY OF THE INVENTION

According to the invention this objective is realized in that the motor bearing is an axial load bearing for absorbing axial forces transmitted by the coupling from the tool unit. The motor positions the tool shaft in axial direction to minimize axial offset in radial direction. The bearing design according to the invention contributes to the objective of the invention in that the motor bearing absorbs axial forces generated by the blending action. When food is being blended, chopped or cut using a hand blender, forces are executed from the tool unit onto the food and counterforces are executed from the food onto the tool unit. These forces are both in an axial and in a radial direction. The axial forces are being transmitted to the axial load bearing located in the motor unit of the hand blender. The transmission of the axial forces to the motor unit of the hand blender reduces the amount of heat dissipated in the tool unit. The radial forces are being absorbed by the bearing in the tool unit.

Conveniently the motor coupling part is arranged to transmit all axial forces to the motor bearing. Only radial forces generated by the interaction between the tool unit and the food have to be absorbed by the bearing in the tool unit. All axial forces generated by the interaction between the tool unit and the food are being transmitted to the bearing of the motor unit via the shaft of the tool unit, the coupling and the motor shaft. The coupling is formed of a motor coupling part in the motor unit and a tool coupling part in the tool unit. When all axial forces are being transmitted to the bearing of the motor unit, the heat generated and dissipated in the tool unit decreases. It is no longer necessary to implement two bearings a radial and an axial load bearing or a combined bearing in the tool unit as only the radial forces are absorbed in the tool unit. Expensive sinter-elements, washer retaining rings can be missed out and the bearing system is less sensitive to production tolerance and thermal expansion.

Preferably the motor coupling part is arranged to tighten upon rotation. The coupling thus tightens the shaft of the tool unit and the motor shaft upon rotation. The tight coupling efficiently transmits all axial forces. When the coupling tightens upon rotation the axial forces generated by the interaction between the tool unit and the food are transmitted to the motor bearing via the shaft of the tool unit, the tool coupling part, the motor coupling part and the motor shaft.

Conveniently the motor coupling part comprises an inclined profile on a mating surface of the motor coupling part. An inclined profile on the mating surface of the motor coupling part may engage with the mating surface of the tool coupling part to tighten the coupling upon rotation. When the motor unit shaft rotates, the inclined profile on its mating surface hitches into the inclined profile on the mating surface of the tool shaft via the coupling, thereby tightening the coupling. A tight coupling allows the transmission of axial forces from the tool unit to the motor unit bearing.

Advantageously the motor coupling part comprises a helical profile on a mating surface. A helical profile on the mating surface of the motor coupling part engages with the mating surface of the tool coupling part to fixate the coupling upon rotation. A helical profile is advantageous as it provides an increased mating surface, thereby reducing the stress onto the respective mating surfaces.

Another embodiment of the motor coupling part according to the invention comprises a magnet. When the tool coupling part is equipped with a magnetizable element, the magnet in the motor coupling part allows the motor coupling part and the tool coupling part to easily connect and align in an axial direction. The mating parts of the magnet and the magnetizable element attract each other and therefore assembly of the tool unit and the motor unit is easy. The appliance of a magnet provides the user with feedback on proper assembly as well. A similar embodiment according to the invention is that the tool coupling part comprises a magnet and that the motor coupling part is equipped with a magnetizable element.

To cooperate with the motor unit and to allow the axial forces to transmit to the motor bearing, the tool coupling part is arranged to transfer axial forces to motor unit. The coupling allows the axial forces to be transmitted from the tool unit to the bearing of the motor unit. When the axial forces are transmitted to the motor unit via the tool unit shaft and the coupling parts, the application of an axial load bearing in the tool unit is no longer necessary. Transmission of the axial forces to the motor bearing results in a reduction of heat dissipation in the tool unit. Therefore the number of parts of the tool unit can be reduced and the design of the tool unit can be less complex.

It is advantageous when the tool coupling part is arranged to transfer all axial forces from the tool unit to the motor unit. Only radial forces generated by the interaction between the tool unit and the food have to be absorbed by the bearing in the tool unit. Axial forces generated by the interaction between the tool unit and the food are being transmitted to the bearing of the motor unit via the shaft of the tool unit, the tool coupling part, the motor coupling part and the motor shaft. When all axial forces are being transmitted to the bearing of the motor unit the heat generated and dissipated in the tool unit decreases. It is no longer necessary to implement two bearings a radial and an axial load bearing or a combined bearing in the tool unit as only the radial forces are absorbed in the tool unit. Expensive sinter-elements, washer retaining rings can be missed out and the system is less sensitive for production tolerance and thermal expansion.

As indicated above it is favorable to the motor coupling part to tighten upon rotation, it is also favorable to the tool coupling part to tighten upon rotation. When the connector of the tool unit connects to the drive, thus forming a tight coupling, axial forces induced in the interaction between the food and the tool unit are fully transmitted to the axial load bearing of the motor unit via the tool unit shaft, the coupling and the motor unit shaft. The transmission of these forces results in a reduction of the friction between the tool unit shaft and the other tool unit parts. The amount of heat generated and dissipated in the tool unit therefore decreased as well.

Another preferred design is that the tool coupling part comprises an inclined profile on a mating surface. An inclined profile on the mating surface of the tool coupling part engages with the mating surface of the motor unit to fix the coupling upon rotation. The purpose of the inclined profile on the mating surfaces of the coupling parts is to lift the tool unit into the required longitudinal direction and to transmit mechanical energy. When the motor shaft rotates, the inclined profile of its mating surface hitches into the inclined profile of the mating surface of the tool shaft via the coupling, thereby tightening the coupling. A tight coupling allows the transmission of axial forces from the tool unit to the motor unit bearing.

Preferably the motor coupling part comprises a helical profile on a mating surface. A helical profile on the mating surface of the tool coupling part engages with the mating surface of the motor unit to fix the coupling upon rotation. A helical profile is advantageous as it provides an increased mating surface, thereby reducing the stress onto the respective mating surfaces.

Conveniently, the tool shaft is at least partly covered with a plastic material. A plastic cover is advantageous on those parts of the tool shaft where friction may occur. Dissipation of the axial forces in the bearing of the motor unit allows the tool unit to be equipped with only a radial bearing. As a consequence of the removal of the axial load bearing from the tool unit shaft it is now possible to cover the tool shaft with a plastic material in a simple manufacturing process, e.g. injection moulding or press fit. The smooth surface of the plastic material results in a reduction of the friction between the tool shaft and the radial bearing. A reduction in friction results in a reduction of heat generation and dissipation. As a consequence of this the radial bearing can be designed less complex as less heat has to be absorbed.

Preferably, at least part of the radial bearing of the tool shaft, arranged to engage with the motor unit according to any of the preceding claims, is made of a plastic material. In the bar cage a bearing tube is present. On the tool shaft at the longitudinal position (in use) of the bearing tube, the tool shaft is overmoulded with plastic bearing material. The plastic bearing material can also be press fitted onto the tool shaft. The plastic bearing material on the tool shaft and the bearing tube are thus forming a radial bearing. Dissipation of the axial forces in the bearing of the motor unit allows the tool unit to be equipped with only a radial bearing. As the friction and the heat generation in the bearing of the blender tool member are reduced with respect to a conventional hand blender, due to the transmission of the axial forces to the motor unit bearing, the radial bearing is less loaded and may be produced of a material that is less resistant to high stress and temperature. It is therefore possible to manufacture the at least part of the radial bearing out of a plastic material.

If the heat generation and dissipation in the radial bearing are significantly reduced, the radial bearing may be fully made of a plastic material. Dissipation of the axial forces in the bearing of the motor unit allows the tool unit to be equipped with only a radial bearing. As the friction and the heat dissipation in the bearing of the blender tool member are reduced due to the transmission of the axial forces to the motor unit bearing, the radial bearing is less loaded and may be produced of a material that is less resistant to high stress and temperature. To reduce production costs the radial bearing may be made of a plastic material.

Another embodiment according to the invention is a hand blender comprising a motor unit and a tool unit comprising any combination of the abovementioned elements.

Although the abovementioned discloses a hand blender comprising two parts: a motor unit and a tool unit, the objective, namely to decrease the heat generation and dissipation in the tool unit, is also realized by an integrated hand blender comprising a motor unit and a tool unit, wherein the motor bearing is an axial load bearing for absorbing axial forces transmitted by the tool drive shaft from the tool member to the motor. Also in an integrated hand blender friction, heat generation and heat dissipation caused by the interaction between the tool member and the food upon food processing is present. Also in an integrated hand blender there is a need for the reduction of friction, heat generation and heat dissipation. Therefore the invention according to the present application will also be beneficial to an integrated hand blender.

The application of the motor bearing for absorbing axial forces generated by the interaction of the tool unit and the food thus results in a less complicated design and a decrease of the number of parts.

The motor unit, tool unit and hand blender according to the invention contribute to the reduction of the longitudinal axis offset between the motor shaft axis and the tool shaft axis, to the reduction of the angular offset of the tool shaft with respect to the motor shaft, to the reduction of the power loss due to friction causing heat, to a reduction of the tolerance between the tool shaft and the motor shaft.

In this patent application the term ‘axial load bearing’ intends to include all bearings that may absorb axial forces. An axial load bearing may absorb only axial forces, a so-called ‘axial load bearing’. An axial load bearing may absorb radial forces as well, a so-called ‘combined bearing’.

### BRIEF DESCRIPTION OF THE DRAWINGS

These and other aspects of the motor unit, tool unit and hand blender of the invention will be further elucidated and described with reference to the drawings in which

FIG. 1A depicts a side elevation of a hand blender with a first tool unit coupled to the blender motor unit;

FIG. 1B depicts a side elevation of the hand blender of FIG. 1A now coupled with a second tool unit;

FIG. 2 schematically illustrates a conventional hand blender in a cross-sectional side view;

FIG. 3 schematically illustrates a hand blender in a cross-sectional side view according to the present disclosure;

FIG. 4 illustrates a tool unit engaged to a motor unit;

FIG. 5 schematically shows a hand blender according to another embodiment of the invention.

### DETAILED DESCRIPTION OF THE DRAWINGS

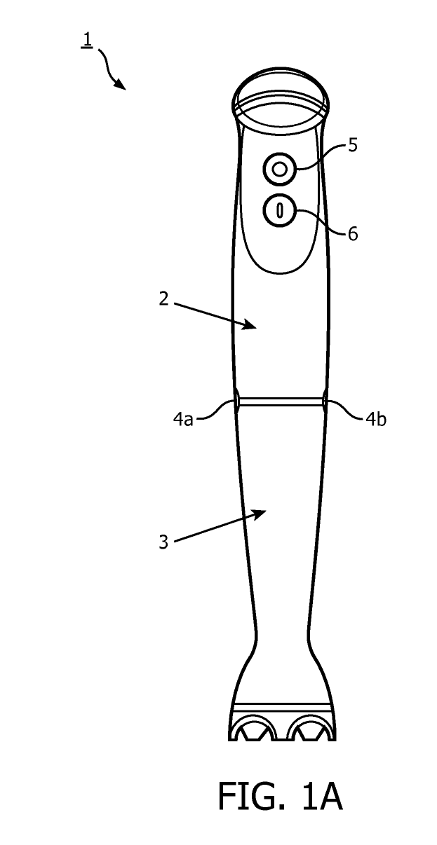

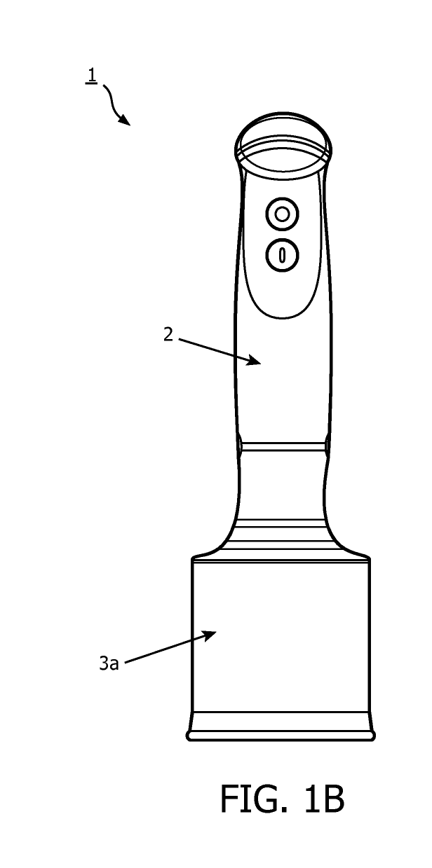

FIG. 1A presents a side view of a hand mixing device or hand blender 1. The hand blender 1 comprises a motor unit 2 and a tool unit 3 that is coupled to the motor unit 2 by means of a coupling assembly (not visible). The motor unit 2 houses a motor (not shown) for driving the tool unit 3. The hand blender 1 is generally used as a kitchen appliance and can be used in the preparation of food. The tool unit 3 is detachably coupled to the motor unit 2 by means of a coupling assembly (not visible) of which one pushbuttons 4a and 4b, with which decoupling of the tool unit 3 and the motor unit 2 can be effected, are just visible. The motor unit 2 of the hand blender 1 further comprises control buttons 5, 6 with which a user can for example turn on and off the hand blender 1 and/or can control the speed of the hand blender 1.

In the example of FIG. 1A the tool unit 3 is a so-called bar blender. Other tool units having different functions can also be coupled to the motor unit 2 by means of the coupling assembly. FIG. 1B gives an example of such another tool unit 3a which is known as a chopper.

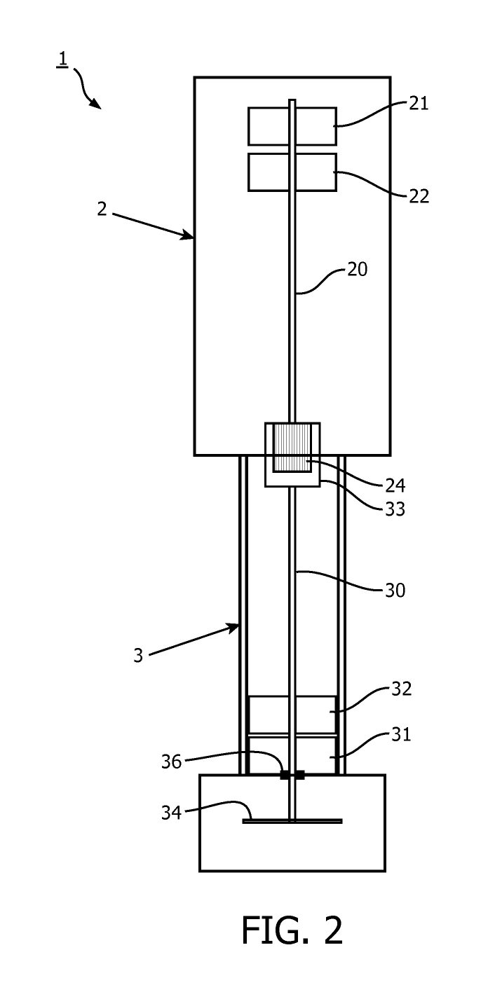

FIG. 2 schematically illustrates a conventional hand blender in a cross-sectional view. The motor unit houses an electrical drive motor (not shown) which is coupled to and arranged for driving a motor drive shaft 20. The drive motor may be battery-powered or may be powered by mains. The motor drive shaft 20 comprises a motor coupling part 24 which can establish a coupling with a tool coupling part 33 of a tool unit 3. The motor coupling part 24 may be designed to be inserted in a tool coupling part 33 of the tool unit 3. The motor coupling part 24 may also be designed as a tubular part in which the tool coupling part 33 of the tool unit 3 can be inserted. In addition to this the motor coupling part 24 may be provided with an internal toothing that is arranged to engage with a similar toothing on the tool coupling part 33 of the tool unit 3. The coupling parts 24, 33 connect to each other forming a coupling.

The electrical drive motor transmits a rotational movement via the motor drive shaft 20 and the coupling to the tool drive shaft 30 of the tool unit 3. The tool drive shaft 30 drives a tool member 34, such as a blender, a chopper or a cube cutter.

The motor unit is equipped with an axial 21 and a radial load bearing 22 to support the electric motor (not shown) and the motor shaft 20 and absorb vibrations, friction and heat generated. Vibrations in the electrical motor cause the motor drive shaft 20 and the electric motor to move with respect to each other. This relative movement results in friction and heat generation. Friction and heat generation will eventually lead to heat dissipation in and wear of the motor unit 2 and/or the coupling. This may lead to early failure of the hand blender.

For reducing the friction, wear and heat generation between the motor drive shaft 20 and the electrical motor the motor drive shaft 20 of the motor unit 2 is supported by an axial load bearing 21 and a radial load bearing 22. The axial load bearing 21 and the radial load bearing 22 may be executed in two separate bearings, one for absorbing each one-directional force. However, both bearings may be integrated into a combined bearing for absorbing both axial and radial forces. On the other hand it is also possible to absorb axial forces in two or more separate bearings. The same applies to radial forces. This solution is often applied when the available space for a bearing is limited.

To stir, blend, cut or shop the food, a user puts the hand blender 1 into the food and pushes the control button 5, 6 (shown in FIG. 1A, 1B) to turn on the hand blender 1. Subsequently the tool member 34 starts to rotate against and through the food, thereby executing forces onto the food. Due to the natural structure and physical properties of the food, the food will execute counterforces onto the tool drive shaft 30 of the tool unit 3. These counterforces will cause friction and heat generation in the tool unit 3: the tool drive shaft 30 will e.g. contact the coupling in an axial direction or contact the fluid tight sealing 36 in a radial direction. Friction and heat generation will eventually lead to heat dissipation in and wear of the tool unit 3 and/or the coupling. This may lead to noise, vibrations, power loss or early failure of the hand blender.

For reducing the friction and heat generation between the tool drive shaft 30 and other parts of the tool unit, the motor drive shaft 30 is supported by an axial load bearing 31 21 for absorbing axial forces and a radial load bearing 32 22 for absorbing radial forces executed on the tool drive shaft and leading to movements and vibrations of the drive shaft 30. The axial load bearing 21 and the radial load bearing 22 may be executed in two separate bearings, one for absorbing each one-directional force. However, both bearings may be integrated into a combined bearing for absorbing both axial and radial forces. On the other hand it is also possible to absorb axial forces in two or more separate bearings. The same applies to radial forces. This solution is often applied when the available space for a bearing is limited.

In a hand blender forces are normally being absorbed as close to the origination of the forces as possible. Therefore an axial load bearing 32, a radial bearing 33 31 or a combined bearing are often located on the side of the tool drive shaft 30, closest to the tool member 34.

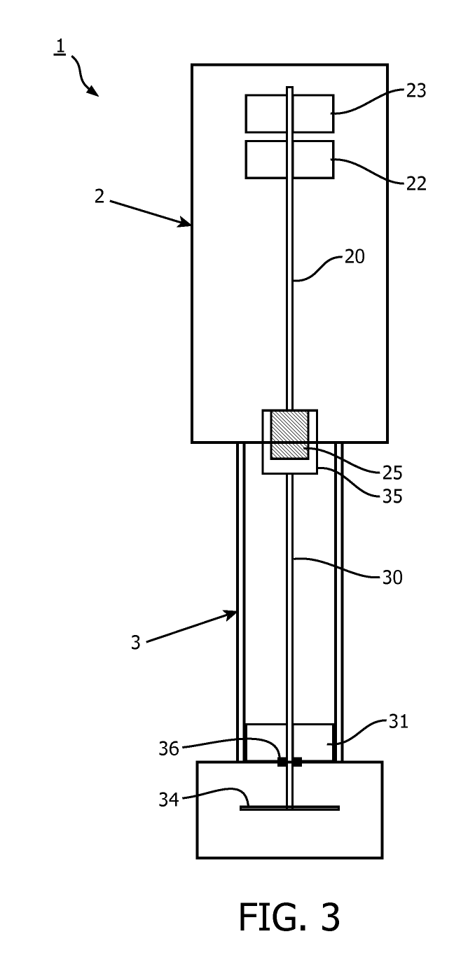

FIG. 3 schematically shows a hand blender according to the invention in a cross-sectional view. The tool drive shaft 30 is connected to the motor drive shaft 20 via a coupling. The coupling is an assembly of two mating parts: the tool coupling part 35 and the motor coupling part 25. The two coupling parts cooperate to allow the axial forces, induced by the interaction between the tool member 34 and the food upon food processing, to transmit to the axial load bearing 23 of the motor unit 2. However, the function of the axial load bearing 23 may be integrated with the function of the radial bearing 22 into a combined bearing for absorbing both axial and radial forces. On the other hand it is also possible that the motor shaft is supported by two or more separate bearings to absorb axial forces. By absorbing the axial forces in the motor unit instead of in the tool unit, heat generation and dissipation in the tool unit 3 are reduced.

The coupling between the tool unit 3 and the motor unit 2 is designed and manufactured to tighten upon rotation. The profiles on the surfaces of both coupling parts are mated such that the profiles do not mate only in an axial direction, but also in a radial direction. In FIG. 3 a helical profile is schematically shown. However, any other inclined profile having a radial component would lead to a tightening coupling upon rotation. A tight coupling allows the axial forces invoked in the tool member 34 to be transferred to the motor bearing 23 without causing friction or generating and/or dissipating heat in the coupling. As there is no axial load bearing friction and heat dissipation in the coupling will eventually lead to wear of the coupling and a lifetime reduction of the hand blender.

Other solutions to axially couple the tool drive shaft 30 and motor drive shaft 20 are also envisionable such as a coupling that via a click connection couples the two coupling parts or magnetic coupling that employs magnetic force to axially couple the two coupling parts.

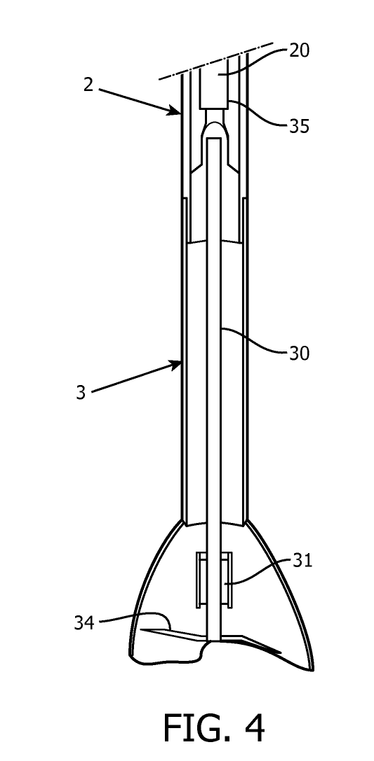

In FIG. 4 the tool unit 3 engaged to the motor unit 2 is disclosed in an open view. The tool unit 3 is connected to the motor unit 2 via the coupling. The coupling is a cooperation of the tool coupling part 35 and the motor coupling part 25. The tool drive shaft 30 is connected to the tool coupling part 35 on the upper side and to the tool member 34 on the lower side. The tool member shaft 30 is supported by a radial load bearing 32 31 for absorbing radial forces. The axial forces are transmitted to the bearing of the motor unit 2. The transmission of axial forces away from the tool unit 3 reduces the friction, heat generation and dissipation in the tool unit 30 and its tool member 34. Therefore elements of the tool unit 3 can be manufactured of a material that is able to withstand fewer load. A plastic material would be preferable as plastic may easily be processed and may be easily improved with additives. It may also be an option to manufacture the tool unit shaft 30 of conventional material, using less material.

The tool drive shaft 30 may be at least partly covered with a plastic material. If the tool drive shaft 30 is covered with a plastic material, the friction between the tool drive shaft 30 and the radial load bearing is significantly reduced and the radial bearing may be a simple sleeve bearing. The plastic may be overmoulded or press fitted onto the tool drive shaft 30. However, other radial bearing types are possible as well, such as a radial ball bearing. Optionally the radial bearing 32 31 is manufactured at least partly of a plastic material.

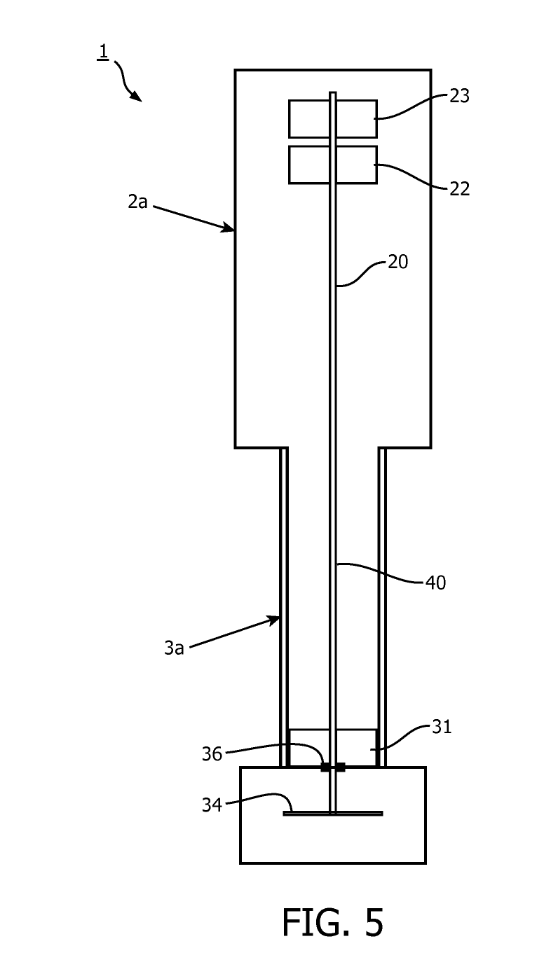

FIG. 5 shows another embodiment of the invention. The motor part 2a and the tool part 3a of the hand blender 1 are manufactured of one part.

To stir, blend, cut or shop the food, a user puts the hand blender 1 into the food and pushes the control button 5, 6 (shown in FIG. 1A, 1B) to turn on the hand blender 1. Subsequently the tool member 34 starts to rotate against and through the food, thereby executing forces onto the food. Due to the natural structure and physical properties of the food, the food will execute counterforces onto the drive shaft 40. These counterforces will cause friction and heat generation in the tool part 3a: the tool drive shaft will e.g. contact the coupling in an axial direction or contact the fluid tight coupling 36 in a radial direction. Friction and heat generation will lead to noise, vibrations, power loss and eventually to wear of the tool unit 3a and/or the coupling. This may lead to early failure of the hand blender.

For reducing the friction and heat generation between the drive shaft 40 and other parts of the tool unit, the drive shaft 40 is supported by a radial load bearing 32 31 for absorbing radial forces executed on the drive shaft 40 and by an axial load bearing 31 22,23 for absorbing axial forces.

In a hand blender forces are normally being absorbed as close to the origination of the forces as possible. Therefore an axial load bearing 32, a radial bearing 33 or a combined bearing are is often located on the side of the drive shaft 40, closest to the tool member 34.

1. A motor unit comprising
a motor
a motor bearing
a motor coupling part driven by the motor for rotating a tool member wherein the motor bearing is an axial load bearing adapted to absorb axial forces transmitted from the tool member by the motor coupling part.

2. A motor unit according to claim 1, wherein the motor coupling part is arranged to transmit all axial forces to the motor bearing.

3. A motor unit according to claim 1, wherein the motor coupling part is arranged to tighten upon rotation.

4. A motor unit according to claim 1, wherein the motor coupling part comprises an inclined profile on a mating surface.

5. A motor unit according to claim 1, wherein the motor coupling part comprises a helical profile on a mating surface.

6. A motor unit according to claim 1, wherein the motor coupling part comprises a magnet.

7. A tool unit with a tool coupling part to be driven by the motor unit, wherein the tool coupling part is arranged to transfer all axial forces to the motor unit.

8. A tool unit according to claim 7 wherein the tool coupling part is arranged to tighten upon rotation.

9. A tool unit according to claim 7 wherein the tool coupling part comprises a magnet.

10. A tool unit according to claim 7, wherein the tool coupling part comprises an inclined profile on a mating surface.

11. A tool unit according to claim 7, arranged to engage with the motor unit, wherein the tool drive shaft is at least partly covered with a plastic material.

12. A tool unit according to claim 7, arranged to engage with the motor unit, wherein radial load bearing is at least partly made of a plastic material.

13. A hand blender comprising a motor unit according to claim 1 and a tool unit, wherein the tool unit and the motor unit are arranged to mate.

14. A hand blender comprising a motor unit and a tool unit wherein the motor bearing is an axial load bearing adapted to absorb axial forces transmitted by the coupling from the tool member to the motor unit.
